(19) United States
(12) Patent Application Publication
(10) Pub. No.: US 2007/0098477 A1
(43) Pub. Date: May 3, 2007

(54) Printer with worm-driven feed roller

(75) Inventors: Jeroen J. Coenen, Venray (NL); Barry B. Goeree, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 11/588,276

(22) Filed: Oct. 27, 2006

(30) Foreign Application Priority Data
Oct. 27, 2005 (EP) 05110071.7

(51) Int. Cl. B41J 13/02

(52) U.S. Cl. 400/636

(57) ABSTRACT

A printing system including: a feed roller engaging a print substrate for intermittently advancing the same, a printhead arranged at a path of the substrate and configured to print an image composed of sub-images that are printed in successive advancing steps of the substrate, a worm wheel drivingly connected to the feed roller, a worm meshing with the worm wheel, a motor for driving the worm, and a motor driver controlling the length of the advance steps, wherein the motor driver is adapted to control the length of the advance steps to be an integral multiple of a unit length (ΔS) that corresponds to one full turn of the worm.

This application claims priority under 35 U.S.C. § 119(a) on Patent Application No. 05110071.7 filed in Europe on Oct. 27, 2005, the entire contents of which is hereby incorporated by reference.

### BACKGROUND OF THE INVENTION

The present invention relates to a printing system comprising: a feed roller engaging a print substrate for intermittently advancing the same, a printhead arranged at a path of the substrate and configured to print an image composed of sub-images that are printed in successive advancing steps of the substrate, a worm wheel drivingly connected to the feed roller, a worm meshing with the worm wheel, a motor for driving the worm, and a motor driver controlling the length of the advance steps.

In a scanning-type printer, a feed roller is frequently used for advancing a sheet of paper or any other print substrate in a specified direction past a printhead, so that the print substrate is scanned with the printhead. The speed or the length of the advance steps with which the sheet is moved relative to the printhead must accordingly be controlled with high accuracy, in order to obtain a good image quality. For example, in a typical set-up of an inkjet printer, a multi-nozzle printhead is mounted on a carriage which travels across the print substrate sheet in a main scanning direction, normal to the direction of sheet advance, so that an image swath or sub-image of several pixel lines is printed on the sheet in each pass of the printhead. Then, the sheet is advanced by the width of the swath, so that the next swath can be printed in a position precisely adjoining to the previous swath. In this case, the width of the sheet advance steps must be controlled with sufficient accuracy, so that the adjacent swaths are perfectly “stitched” together and will neither overlap nor form a gap. If the resolution of the printer is 600 dpi, for example, the width of a single pixel line is only 42 μm, and the tolerances allowed for the length of the sheet advance step must even be significantly smaller than this.

A worm-type drive mechanism has the advantage that it provides a high transmission ratio, so that the speed of revolution of the worm is much larger that that of the feed roller. As a consequence, the sheet advance increments provided by the feed roller amount only to a small fraction of the angular increments of the worm, so that a high control accuracy can be achieved by counting the worm increments.

Ideally, there is a linear relation between the speed of revolution of the worm and the sheet advance speed. In practice, however, some periodic non-linearities come into play, which are due, for example, to eccentricities of the feed roller, the worm wheel, and/or the worm. Eccentricities of the feed roller and the worm wheel lead to long-periodic fluctuations in the sheet advance speed, and the positioning errors resulting therefrom can be compensated for by suitable calibration techniques. However, eccentricities of the worm lead to short-periodic fluctuations which are more difficult to eliminate by calibration.

### SUMMARY OF THE INVENTION

Accordingly, it is an object of the present invention to provide a printer in which errors in the length of the advance steps of the print substrate, especially errors resulting from short, periodic fluctuations in the worm-type drive mechanism, can be avoided in a simple and reliable way.

To this end, according to the present invention, the motor driver is adapted to control the length of the advance steps to be an integral multiple of a unit length that corresponds to one full turn of the worm. Thus, although the advance speed of the substrate still includes the short-periodic fluctuations, these fluctuations will have no effect on the length of the advance step because the length of the advance step will always be in registry with the periodicity of the fluctuations. Of course, as regards the length of the advance steps, there is only a limited freedom of choice, because this length must be adapted with high accuracy to the width of the swath that is being printed and, accordingly, depends upon the configuration of the printhead and possibly also on the print mode that is being used. Consequently, the present invention involves the idea that the dimensions of the feed roller and its drive mechanism, e.g., the diameter of the feed roller, the transmission ratio of the worm transmission, and the like, are adapted to the configuration of the printhead.

Many printers are adapted to be operated in different print modes. For example, one print mode may be a single-pass mode, in which a complete sub-image is printed in a single pass of the printhead, so that the length of the advance step of the print substrate corresponds to the length of the printhead in the direction of advance. In a multi-pass mode, only a fraction of the pixels of a sub-image is printed in the first pass, the substrate is then advanced by only a fraction of the total length of the printhead, and the remaining fraction or fractions of the pixels are printed in subsequent passes. In this case, the configuration of the printhead and the dimensions of the feed roller and the drive mechanism are so adapted to the various print modes that the length of the advance steps in the various print modes all correspond to integral multiples of the unit length.

### BRIEF DESCRIPTION OF THE DRAWINGS

A preferred embodiment of the present invention will now be described in conjunction with the drawings, in which:

FIG. 1 is a schematic perspective view of a printer according to the present invention;

FIGS. 2 and 3 are sectional views of a worm wheel and a worm in different positions;

FIG. 4 is a diagram showing short-periodic fluctuations in the advance speed of a print substrate as a function of an angle of rotation of the worm; and

FIGS. 5 and 6 are diagrams illustrating different print modes of the printer.

### DETAILED DESCRIPTION OF THE INVENTION

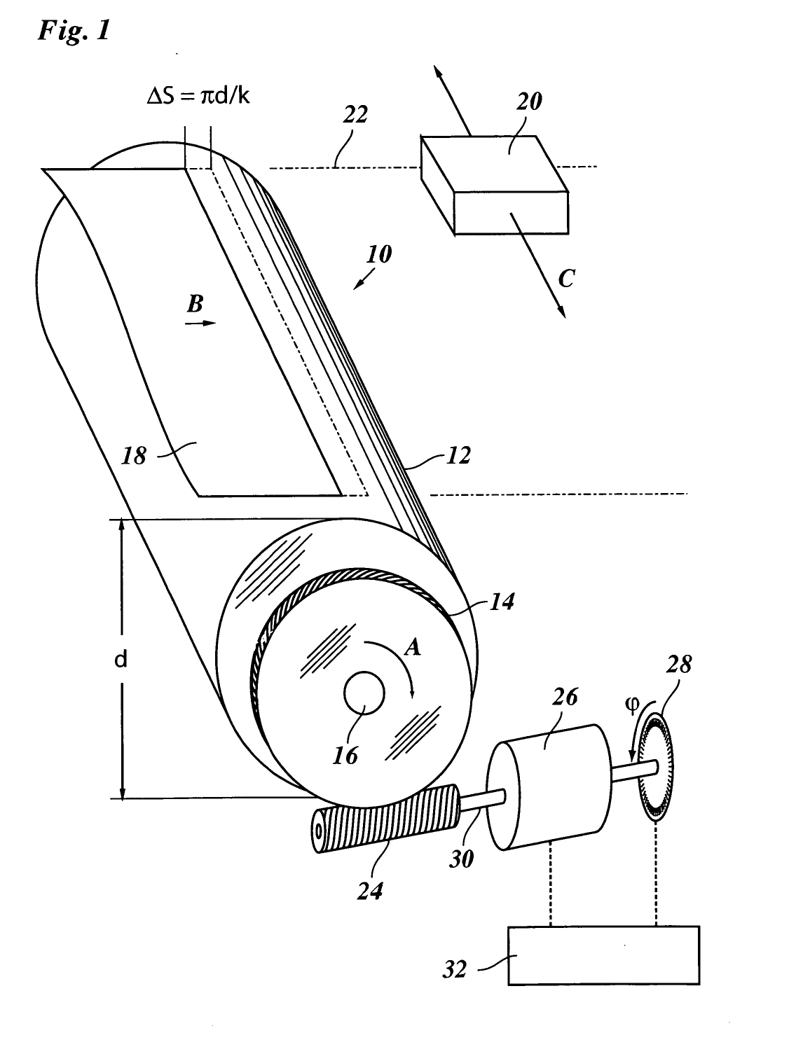

As is shown in FIG. 1, a rotary unit 10 of a printer, e.g., an inkjet printer, comprises a feed roller 12 and a worm wheel 14 mounted for joint rotation on a common axle 16. When the rotary unit 10 is rotated in the direction of an arrow A, a sheet of a print substrate 18, e.g., paper, is advanced in a direction B relative to a printhead 20 along a path 22. The direction B is the sub-scanning direction of the printer, whereas the main scanning direction C, is the direction in which the printhead 20 moves back and forth across the path 22 of the substrate.

A worm 24 is mounted to mesh with the worm wheel 14 and is driven by an electric motor 26. A disk-type encoder 28 is mounted on a drive shaft 30 of the motor 26 so as to detect angular increments by which the worm 24 is rotated in a direction φ. By way of example, the encoder 28 may have 500 slots, so that, utilizing quadrature encoding, it is possible to detect the angular increments with a resolution of 2000 per revolution of the worm.

The worm gear formed by the worm 24 and the worm wheel 14 provides a very small transmission ratio 1/k<<1, so that a relatively large angular displacement of the worm 24 leads only to a relatively small advance of the substrate 18. Thus, in principle, the encoder 24 permits a fine control of the sheet advance with a very high accuracy. The number k is preferably an integer and indicates the number of turns that the worm 24 has to make for causing the rotary unit 10 to make one complete turn. Thus, when the worm 24 is rotated by 360° (a full turn), the substrate 18 will be advanced by a unit length ΔS=πd/k, with d being the diameter of the feed roller 12.

A motor driver 32 receives the angular increments of the worm 24 as detected by the encoder 28 and controls the motor 26 so as to advance the substrate 18 by a required length, each time the printhead 20 has performed a pass across the substrate.

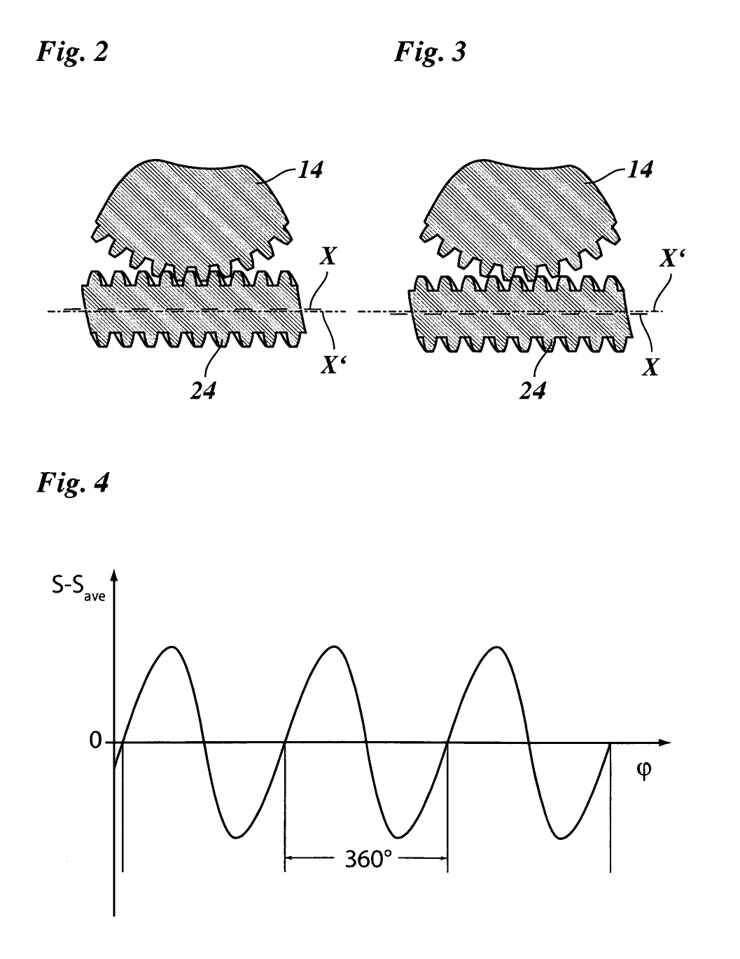

FIGS. 2 and 3 are cross-sectional views of the worm wheel 14 and the worm 24 and illustrate the effect of an eccentricity of the worm 24 on the advance speed of the substrate. The geometric central axis X of the worm 24 is indicated by a broken line, whereas a dotted line represents the actual axis X′ of rotation of the worm. As can be seen in the drawings, a slight offset between the axes X and X′ reflects a certain eccentricity of the worm 24.

In FIG. 2, the geometric central axis X of the worm is located above the axis of rotation X′. As a result, when the worm 24 is rotated with a constant angular speed about the axis X′, the helical teeth of the worm meshing with the teeth of the worm wheel 14 move on a larger radius and, consequently, drive the worm wheel with a speed that is slightly larger than the average or nominal speed. In contrast, in the situation shown in FIG. 3, the worm 24 has been rotated about 180°, so that, now, the geometric central axis X is below the axis of rotation, and the teeth meshing with the worm wheel move on a smaller radius, so that the worm wheel is driven with a speed smaller than the nominal speed. Thus, the eccentricity of the worm 24 results in speed fluctuations of the worm wheel 14 and, consequently, of the substrate 18, and these fluctuations have the same period as the rotation of the worm 24. This fact is illustrated diagramatically in FIG. 4, where the deviation S−Sₐᵥₑ of the actual substrate displacement S from the average displacement Sₐᵥₑ (at a constant rotational speed of the worm 24) is indicated as a function of the angle φ of rotation of the worm 24.

When the printhead 20 is moved across the substrate and has printed a swath of the image on the substrate, the substrate must be advanced by a length that exactly corresponds to the width of the swath (with tolerances smaller than the resolution of the printed image). If the length of this advance step is determined without taking the properties of the drive mechanism into consideration, then the error in the position of the substrate relative to the printhead would be given by any one of the deviations S−Sₐᵥₑ shown in FIG. 4, and the required tolerances could not be met. However, in the present embodiment, the configurations of the printhead 20 and the drive mechanism are so adapted to one another that the required length of the advance step of the substrate 18 can always be obtained by causing the worm 24 to make an integral number of full turns. As a result, when the substrate 18 is advanced in successive steps, the errors in the position of the substrate 18 relative to the printhead 20 will always be the same, and, consequently, the errors in position of the printed swaths relative to one another will always be zero, in spite of the eccentricity of the worm 24. In other words, the unit length ΔS (FIG. 1) of the displacement of the substrate obtained with a full turn of the worm 24 is independent of the eccentricity of the worm, and when the length of the advance step between subsequent print passes is an integral multiple of this unit length ΔS, the eccentricity of the worm, or any other fluctuations that have the period rotation of the worm, will not cause any defects in the printed image.

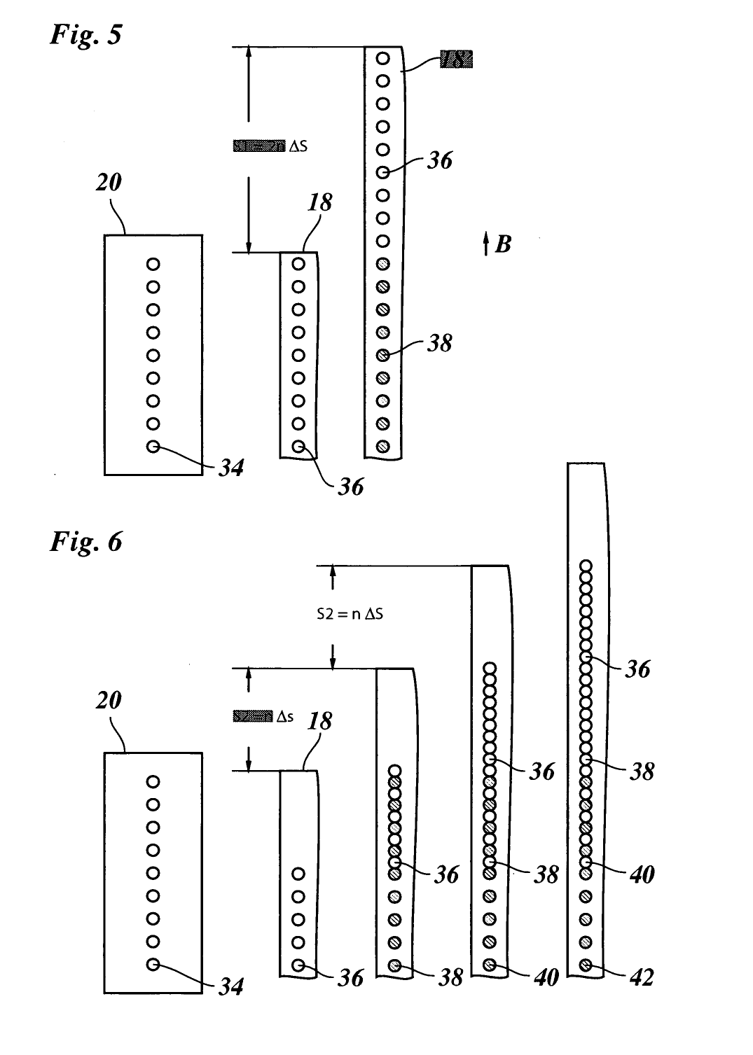

FIG. 5 is a diagram illustrating a single-pass print mode. The printhead 20 has a linear array of print elements 34, i.e., nozzles in the case of an ink jet printer, which are arranged in the direction B. Adjacent to the printhead 20, an edge portion of the substrate 18 is shown in the position at the end of a first print pass, in which each nozzle has printed a pixel 36 on the substrate. Then, the substrate 18 is advanced by an advance step having the length S1=2n Δs (n being an integer) and reaches the position indicated as 18′. Then, the next print path is performed by moving the printhead 20 across the substrate, so that another swath of pixels 38 is printed in a position exactly adjoining the swath of pixels 36 printed in the first pass. It will be understood that, in practice, the number of print elements 34 provided on the printhead 20 will be considerably larger than shown in FIG. 5.

FIG. 6 is a diagram analogous to FIG. 5 and illustrates a two-pass print mode. In the first print pass, only some of the print elements 34 are active, so that the number of pixels 36 printed in that pass corresponds approximately to one half of the number of print elements on the printhead. It should be noted that the number of print elements 34 on the printhead 20 is an odd number. Then, the substrate 18 is advanced by an advance step having the length S2=n Δs, i.e. only half of the length of the advance step S1 in FIG. 5. The next print pass creates the pixels 38, some of which are exactly interleaved with the previously printed pixels 36. Subsequent advance steps and print passes will successively create pixels 40, 42, the pixels forming an image that, in the sub-scanning direction B, has twice the resolution that can be obtained in a single-pass mode. The exact positioning of the pixels 36, 38, 40, 42 relative to one another is guaranteed by the fact that in both print modes, the lengths S1 and S2 of the advance steps are integral multiples of ΔS. A person skilled in the art will understand that this concept can be extended in a straightforward manner to multi-pass modes with more than two passes.

In a modified embodiment, a detection system (not shown) may be provided for detecting the angular position of the worm wheel 14, and the motor driver 32 may be adapted to carry out a correction or calibration for long-periodic errors that may be caused by eccentricity or other defects of the worm wheel 14 or the rotary unit 10 as a whole. Then, the condition that the length of the advance step should be an integral multiple of ΔS applies to the non-corrected length of the advance step, and the correction will be carried out by a slight additional forward or rearward rotation of the worm 24. However, the angle of this additional rotation, which is necessary for correcting the long-periodic fluctuations, is comparatively small, so that the effect of the short-periodic fluctuations (FIG. 4) that are caused by such a small angular displacement will be negligible.

The invention being thus described, it will be obvious that the same may be varied in many ways. Such variations are not to be regarded as a departure from the spirit and scope of the invention, and all such modifications as would be obvious to one skilled in the art are intended to be included within the scoped of the following claims.

1. A printing system which comprises:
a feed roller adapted to engage a print substrate for intermittently advancing the substrate,
a printhead arranged at a path of the substrate and configured to print an image composed of sub-images that are printed in successive advancing steps of the substrate,
a worm wheel drivingly connected to the feed roller, a worm meshing with the worm wheel,
a motor for driving the worm, and
a motor driver for controlling the length of the advancing steps,
wherein the motor driver is adapted to control the length (S1; S2) of the advance steps to be an integral multiple of a unit length (ΔS) that corresponds to one full turn of the worm.

2. The printing system according to claim 1, wherein the motor driver is adapted to produce advancing steps of different length (S1, S2) in accordance with different print modes of the printer, each of the different lengths (S1, S2) being an integral multiple of said unit length (ΔS).

3. An ink jet printer containing the printing system of claim 1.

4. An ink jet printer containing the printing system of claim 2.
